(19) United States
(12) Patent Application Publication
(10) Pub. No.: US 2026/0177219 A1
(43) Pub. Date: Jun. 25, 2026

(54) VEHICLE LAMP

(71) Applicant: Ichikoh Industries, Ltd., Isehara-shi (JP)

(72) Inventors: Hiroya IMAMURA, Isehara-shi (JP); Kazunori IWASAKI, Isehara-shi (JP)

(73) Assignee: Ichikoh Industries, Ltd., Isehara-shi (JP)

(21) Appl. No.: 19/129,209

(22) PCT Filed: Nov. 22, 2023
(86) PCT No.: PCT/JP2023/042022

§ 371 Date: May 12, 2025

(30) Foreign Application Priority Data
Nov. 24, 2022 (JP) 2022-187327

(51) Int. Cl. F21S 43/14; F21S 41/151; F21S 41/24; F21S 41/25; F21S 41/255; F21S 41/32; F21S 41/33

(52) U.S. Cl. CPC F21S 43/14; F21S 41/151; F21S 41/24; F21S 41/25; F21S 41/255; F21S 41/322; F21S 41/338

(57) ABSTRACT

A vehicle lamp, which is capable of partially adjusting the light distribution, includes a light source unit including a plurality of light-emitting elements, a lens provided in front of the light source unit, and a reflective surface provided below the plurality of light-emitting elements and between the light source unit and the lens. An inclination angle of a first reflective surface, which is a partial region of the reflective surface in a vehicle width direction, with respect to the lens optical axis is smaller than that of an adjacent region that is adjacent to the first reflective surface in the vehicle width direction.

### TECHNICAL FIELD

The present disclosure relates to a vehicle lamp.

### BACKGROUND ART

Patent Literature 1 discloses a driving headlamp that emits an adaptive driving beam (ADB) to the front side of a vehicle. The light distribution of the ADB is automatically controlled to change in accordance with a situation (the presence or absence of a preceding vehicle or an oncoming vehicle, the distance to a preceding vehicle or an oncoming vehicle, or the like) in front of the vehicle. Components of the driving headlamp are a heat sink, a light source unit, a cell structure, and a projection lens. A seat portion is provided on a front surface of the heat sink, and the light source unit and the cell structure for controlling light from the light source unit are attached to the seat portion. The cell structure is provided with left and right reflectors that reflect light from the light source unit to the outer side in the vehicle width direction to the front projection lens and reflect light from the light source unit to the inner side in the vehicle width direction to the front projection lens.

### CITATION LIST

### Patent Literature

Patent Literature 1: Japanese Unexamined Patent Application Publication No. 2016-115641

### SUMMARY OF THE INVENTION

### Problems to be Solved by the Invention

In a driving headlamp (vehicle lamp) described in Patent Literature 1, the left and right reflectors reflect the light from the light source unit to the outer side in the vehicle width direction and the light to the inner side in the vehicle width direction to the front projection lens. However, since the left and right reflectors have a uniform shape, it is difficult to partially adjust the light distribution.

Therefore, an object of the present disclosure is to provide a vehicle lamp with which the light distribution can be partially adjusted.

### Means for Solving the Problem

To solve the above-described issue, according to a first aspect of the present invention, a vehicle lamp is mounted on a front portion of a vehicle, the vehicle lamp includes a light source unit including a plurality of light-emitting elements arranged horizontally in a vehicle width direction, a lens provided in front of the light source unit, and a reflective surface that is provided below the plurality of light-emitting elements and between the light source unit and the lens and that reflects downward light, which is not incident as direct light on the lens from the plurality of light-emitting elements, and causes the downward light to be incident on the lens as reflected light, and an inclination angle of a partial region of the reflective surface in the vehicle width direction with respect to a lens optical axis of the lens is smaller than an inclination angle of an adjacent region that is adjacent to the partial region in the vehicle width direction.

A second aspect of the present invention is the vehicle lamp according to the first aspect, and an intersection point where a reverse optical path obtained by extending backward an optical path of reflected light from the partial region of the reflective surface intersects with a vertical axis included in a plane that passes through a light emission center of the light-emitting element and is perpendicular to the lens optical axis is located below the intersection point in a case where the inclination angle of the partial region is set to be the same as the inclination angle of the adjacent region, and the lens emits the reflected light from the partial region of the reflective surface, beyond reflected light in a case where the inclination angle of the partial region is set to be the same as the inclination angle of the adjacent region.

A third aspect of the present invention is the vehicle lamp according to the first aspect, and the partial region of the reflective surface is provided on an inner side in the vehicle width direction with respect to the lens optical axis.

A fourth aspect of the present invention is the vehicle lamp according to the first aspect, and the partial region of the reflective surface is provided at an upper end portion of the reflective surface.

A fifth aspect of the present invention is the vehicle lamp according to the fourth aspect, the upper end portion of the reflective surface is provided with a recessed portion that is recessed downward, and the partial region of the reflective surface is a bottom surface of the recessed portion.

A sixth aspect of the present invention is the vehicle lamp according to the fourth aspect, the reflective surface is provided with a strip-shaped protruding portion that extends from an upper end to a lower end of the reflective surface in an upwardly protruding state, and the partial region of the reflective surface is an upper surface of an upper end portion of the protruding portion.

A seventh aspect of the present invention is the vehicle lamp according to the second aspect, and the reflective surface is provided below a straight line connecting a lower end of an incident surface of the lens, on which direct light from the light-emitting element is incident, and the light emission center of the light-emitting element in a vertical cross-section including a straight line that passes through the light emission center of the light-emitting element and is parallel to the lens optical axis.

### Effect of the Invention

According to the present disclosure, it is possible to provide a vehicle lamp with which the light distribution can be partially adjusted.

### BRIEF DESCRIPTION OF THE DRAWINGS

FIG. 1 is a plan view of a vehicle equipped with a vehicle lamp according to an embodiment of the present invention.

FIG. 2 is a schematic horizontal cross-sectional view of a right lamp unit.

FIG. 3 is a schematic cross-sectional view of the lamp unit taken along the line III-III in FIG. 2.

FIG. 4 is a front view of the right lamp unit with a lens removed.

FIG. 5 is a perspective view of a reflector of the right lamp unit.

FIG. 6 is a cross-sectional view taken along the line VI-VI in FIG. 5.

FIG. 7 is an explanatory diagram of reflected light that is reflected by a reflective surface.

FIG. 8 is a diagram illustrating light distribution patterns of the right lamp unit projected on a screen, in which (a) illustrates a state in which a recessed portion is not provided, (b) illustrates a state in which the recessed portion is provided, and (c) illustrates an increase in the light in (b) with respect to (a).

FIG. 9 is a diagram illustrating light distribution patterns and changes in illuminance of a vehicle on a sidewalk, in which (a) illustrates a light distribution pattern in a state where the recessed portion is not provided, (b) illustrates a light distribution pattern in a state where the recessed portion is provided, and (c) illustrates a change in the illuminance in the vertical direction on a sidewalk.

FIG. 10 is a perspective view illustrating a modification of the reflector.

FIG. 11 is a cross-sectional view taken along the line XI-XI of FIG. 10.

### MODE FOR CARRYING OUT THE INVENTION

An embodiment of the present invention will be described below with reference to the drawings. In each drawing, FR indicates the front side of a vehicle, UP indicates the upper side, and IN indicates the inner side in a vehicle width direction. Further, in the following description, the front-rear direction refers to the front-rear direction of the vehicle, and the right-left direction refers to the right-left direction in a state of facing the front side of the vehicle. Further, the inner side in the vehicle width direction refers to the direction toward the center of the vehicle in the vehicle width direction, and the outer side in the vehicle width direction refers to the direction away from the center of the vehicle in the vehicle width direction. Since the drawings are schematic diagrams, the main components are illustrated, the components other than the main components are not illustrated, and a part of hatching is omitted.

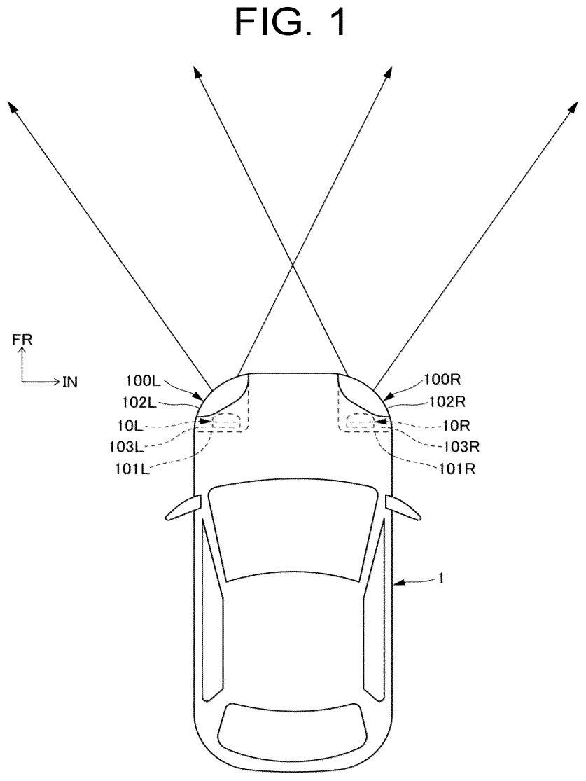

FIG. 1 is a plan view of a vehicle equipped with a vehicle lamp according to an embodiment of the present invention. The arrows to the front side from a vehicle headlamp in FIG. 1 indicates light emitted from the vehicle headlamp.

As illustrated in FIG. 1, a vehicle 1 equipped with a vehicle lamp according to an embodiment of the present invention includes left and right vehicle headlamps 100L, 100R at a front portion of the vehicle 1. The left vehicle headlamp 100L is provided on the left side of the front portion of the vehicle 1, and the right vehicle headlamp 100R is provided on the right side of the front portion of the vehicle 1.

### Vehicle Headlamp

The vehicle headlamps 100L, 100R include lamp housings 101L, 101R having an opening to the front side, outer lenses 102L, 102R covering the openings of the lamp housings 101L, 101R, and lamp units 10L, 10R provided in lamp chambers 103L, 103R partitioned by the lamp housings 101L, 101R and the outer lenses 102L, 102R, respectively. The lamp housings 101L, 101R are made of a light-impermeable resin material. The outer lenses 102L, 102R are made of a light-permeable resin material. The outer lenses 102L, 102R may be outer covers made of a light-permeable resin material.

### Lamp Unit

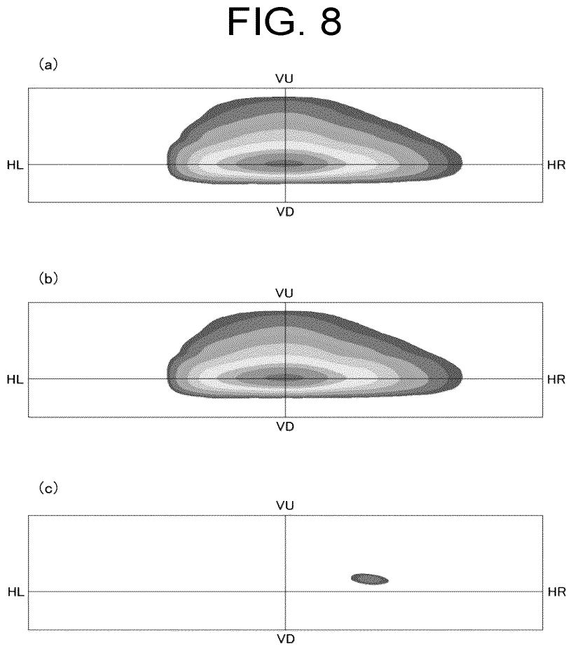

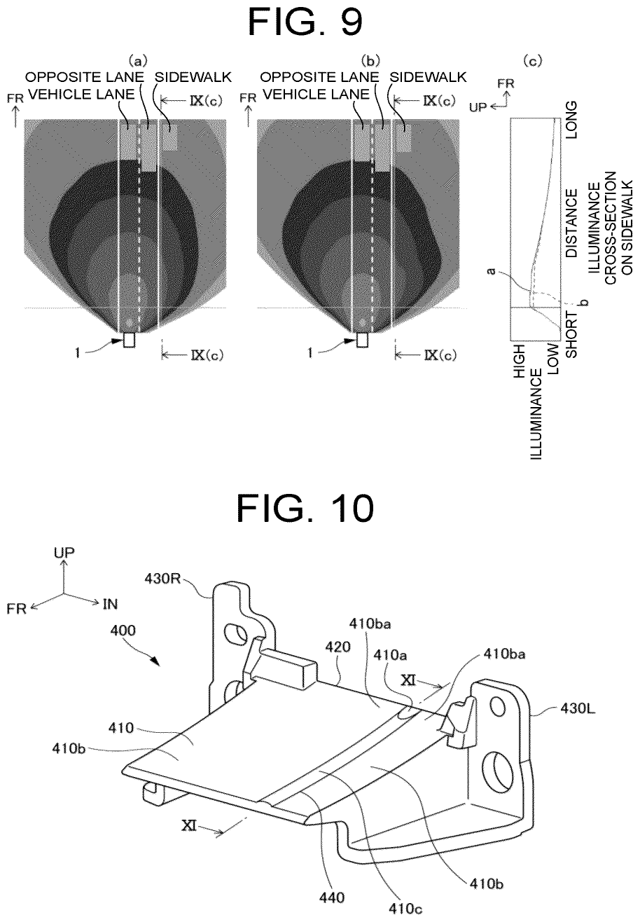

The left lamp unit 10L emits a left high-beam light distribution pattern (not illustrated) to the front side of the vehicle 1. Conversely, the right lamp unit 10R emits a right high-beam light distribution pattern (see FIG. 8(b)) to the front side of the vehicle 1. The left high-beam light distribution pattern and the right high-beam light distribution pattern are superimposed on each other to form one entire high-beam light distribution pattern (see FIG. 9(b)). In this example, the entire high-beam light distribution pattern is a wide high-beam light distribution pattern that illuminates a wide range from the vicinity of the front side of the vehicle 1 to a far side of the front side with high light intensity.

The lamp units 10L, 10R of the left and right vehicle headlamps 100L, 100R are light distribution variable type lamp units and are what are called ADB (Adaptive Driving Beam) type lamp units. The left and right lamp units 10L, 10R emit the entire high-beam light distribution pattern (see FIG. 9(b)) when there are no vehicles on the front side such as oncoming vehicles or preceding vehicles. Conversely, when there is a vehicle on the front side, the left and right lamp units 10L, 10R control the area where there is a vehicle on the front side so as to become darker than the surrounding area, thereby suppressing glare light for the vehicle on the front side. That is, the left and right lamp units 10L, 10R are controlled by a control device (not illustrated) to turn on and turn off a plurality of light-emitting elements 22 of a light source unit 20 described below and increase and decrease the light intensity and thus change the entire high-beam light distribution pattern.

The vehicle lamp according to the present embodiment is applied to, for example, the vehicle headlamp (vehicle lamp) 100R on the right side of the vehicle 1. The vehicle lamp according to the present disclosure may be applied to the left vehicle headlamp 100L, or may be applied to both of the left and right vehicle headlamps 100L, 100R.

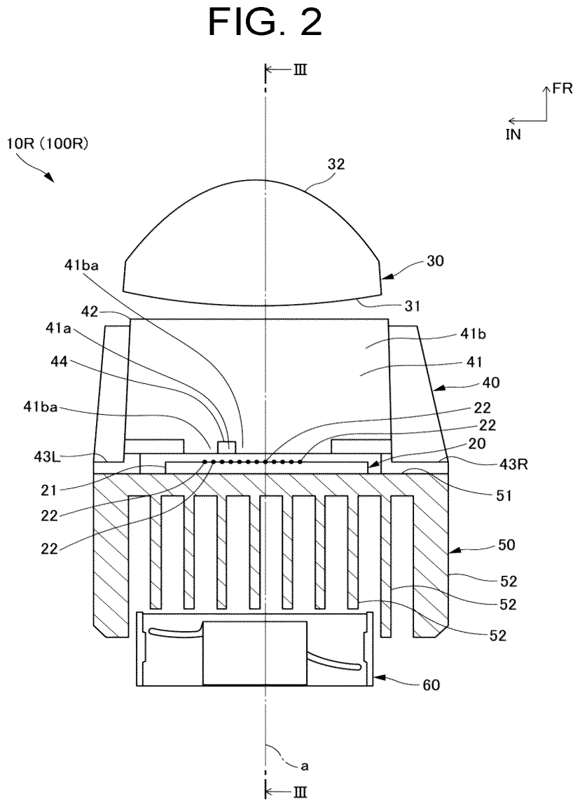

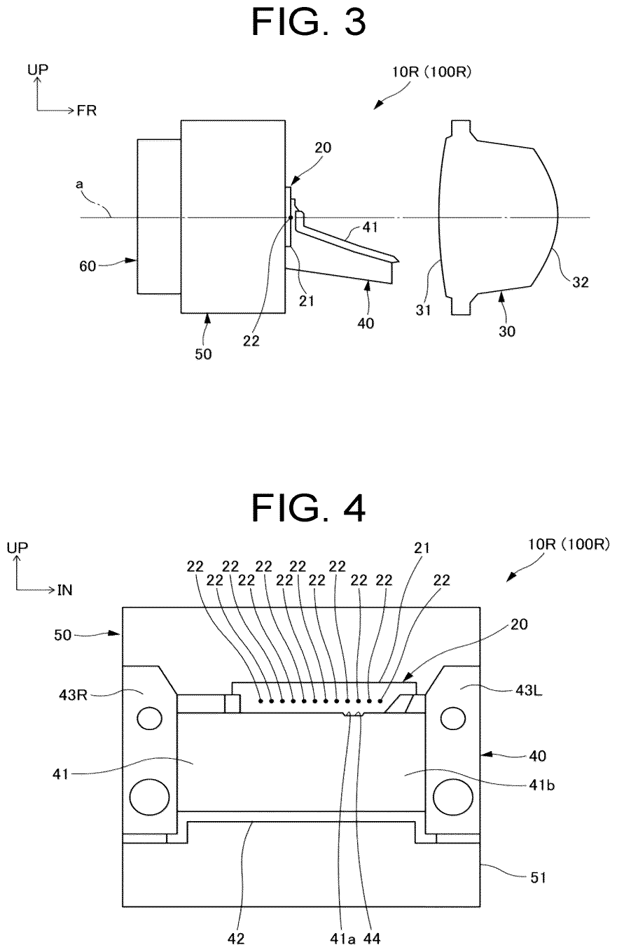

FIG. 2 is a schematic horizontal cross-sectional view of the right lamp unit 10R. FIG. 3 is a schematic cross-sectional view of the lamp unit 10R taken along the line III-III in FIG. 2. FIG. 4 is a front view of the right lamp unit 10R with a lens removed. A dash-dotted line a in FIGS. 2 and 3 indicates a lens optical axis a of the lens 30. Hatching of the cross-section is partially omitted.

As illustrated in FIGS. 2 to 4, the lamp unit 10R of the right vehicle headlamp 100R includes the light source unit 20, the lens 30 provided in front of the light source unit 20, a reflector 40 provided between the light source unit 20 and the lens 30, a heat sink 50, and a fan unit 60. The reflector 40 has a reflective surface 41 that reflects light from the light source unit 20 to the lens 30. As described above, the vehicle headlamp 100R includes the light source unit 20, the lens 30, and the reflective surface 41. The lamp unit 1OR is attached to the lamp housing 101R via a frame member or a bracket member (not illustrated). The left and right lamp units 10L, 10R are provided symmetrically with respect to the right-left direction of the vehicle 1 and have substantially the same configuration except for the shape of the reflector 40.

### Light Source Unit

The light source unit 20 includes a substrate 21 and the plurality of light-emitting elements 22 arranged horizontally in the vehicle width direction on one surface (front surface) of the substrate 21. The other surface (rear surface) of the substrate 21 is attached to the heat sink 50. The light source unit 20 according to the present embodiment includes the 12 light-emitting elements 22. The 12 light-emitting elements 22 are an LED (Light-Emitting Diode) array and are arranged in the horizontal direction on the substrate 21, and 12 light distribution patterns are formed by light from the respective light-emitting elements 22. The 12 light distribution patterns are arranged in the horizontal direction so as to partially overlap at least the adjacent light distribution pattern, and form the entire light distribution pattern. According to the present embodiment, among the light-emitting elements 22 arranged in the horizontal direction, the fifth light-emitting element 22 from the outer side in the vehicle width direction is located on the lens optical axis a of the lens 30. The position of the lens optical axis a is not limited to the position overlapping the fifth light-emitting element 22 from the outer side in the vehicle width direction. For example, the lens optical axis a may be located between the two adjacent light-emitting elements 22.

Light (radiation light, emission light) radiated (emitted) from the light-emitting surfaces of the plurality of light-emitting elements 22 forms a Lambertian shape. As a result, the light is emitted from the plurality of light-emitting elements 22 to the front side of the vehicle 1 over a wide range in the vertical and horizontal directions. Most of the light from the plurality of light-emitting elements 22 is incident as direct light on an incident surface 31 (effective incident surface) of the lens 30. Further, the downward light that is not incident as direct light on the lens 30 from the plurality of light-emitting elements 22 is reflected by the reflective surface 41 of the reflector 40 described below and is incident as reflected light on the incident surface 31 of the lens 30.

According to the present embodiment, the plurality of light-emitting elements 22 is provided on the one substrate 21, but this is not a limitation. For example, the light source unit may be configured by arranging a plurality of substrates including the one light-emitting element 22 in the horizontal direction. In addition, according to the present embodiment, the light-emitting element 22 is an LED (light-emitting diode), but this is not a limitation, and for example, the light-emitting element 22 may be an LD (laser diode). The shape of the light-emitting element 22 is not particularly limited, and may be a square shape or a rectangular shape. Further, according to the present embodiment, the number of the light-emitting elements 22 provided is 12, but this is not a limitation, and may be 11 or less, or 13 or more.

### Reflector

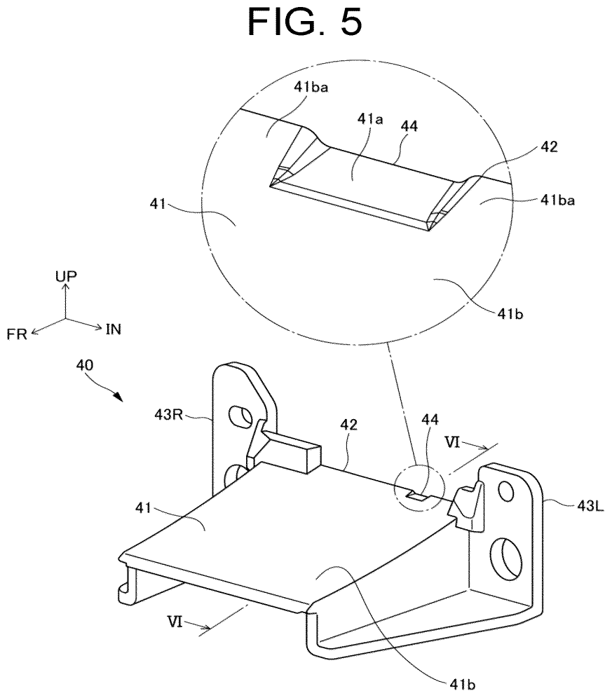

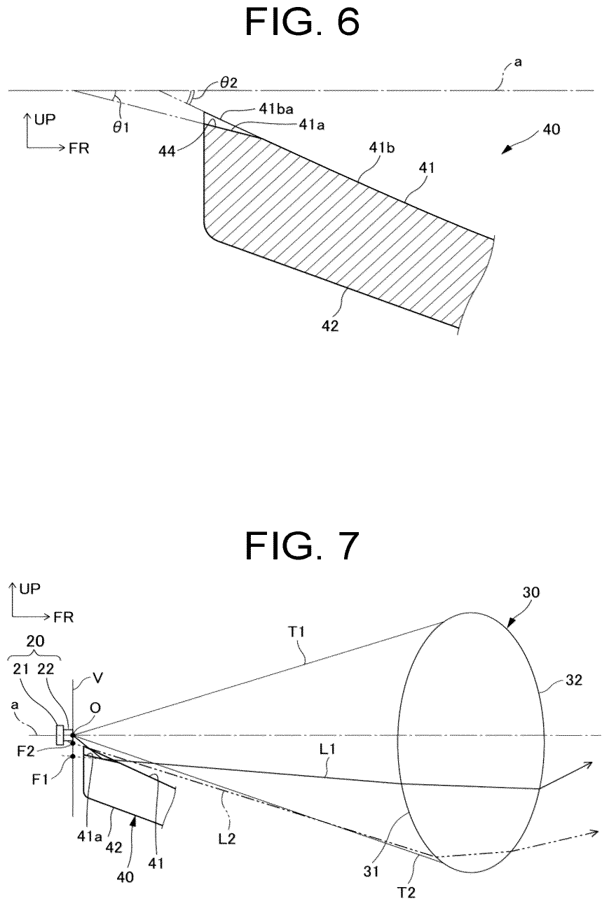

FIG. 5 is a perspective view of the reflector 40 of the right lamp unit. FIG. 6 is a cross-sectional view taken along the line VI-VI of FIG. 5. FIG. 7 is an explanatory diagram of reflected light that is reflected by the reflective surface. Straight lines T1, T2 illustrated in FIG. 7 indicate an upper end and a lower end of the range in which the light from the light-emitting element 22 is incident as direct light on the incident surface 31 of the lens 30.

As illustrated in FIGS. 5 and 6, the reflector 40 includes a reflector main body 42 and left and right fixing portions 43L, 43R integrally provided on both left and right sides of the reflector main body 42.

The left fixing portion 43L is located on the left side (the inner side in the vehicle width direction) of the plurality of light-emitting elements 22 and is fixed to the heat sink 50 (see FIGS. 2 to 4). Further, the right fixing portion 43R is located on the right side (the outer side in the vehicle width direction) of the plurality of light-emitting elements 22 and is fixed to the heat sink 50 (see FIGS. 2 to 4). Thus, the reflector 40 is fixed to the heat sink 50. The reflector main body 42 is provided below the lower end (the position indicated by the straight line T2 in FIG. 7) of the range in which the light from the light-emitting element 22 is incident as direct light on the incident surface 31 of the lens 30 in a vertical cross-section including the straight line that passes through a light emission center O of the light-emitting element 22 and is parallel to the lens optical axis a.

### Reflective Surface

The reflector main body 42 has an upper surface (the reflective surface 41) extending forward and downward from the heat sink 50 side (rear side). The upper surface of the reflector main body 42 functions as the reflective surface 41 that causes the light from the plurality of light-emitting elements 22 to be incident as reflected light on the lens 30. The reflective surface 41 of the reflector main body 42 is provided below the plurality of light-emitting elements 22 and between the light source unit 20 and the lens 30. The reflective surface 41 is provided below the lower end (the position indicated by the straight line T2 in FIG. 7) of the range in which the light from the light-emitting element 22 is incident as direct light on the incident surface 31 of the lens 30 in the vertical cross-section including the straight line that passes through the light emission center O of the light-emitting element 22 and is parallel to the lens optical axis a. Further, the reflective surface 41 for reflecting the light is preferably subjected to aluminum vapor deposition to increase reflectance.

The reflective surface 41 of the reflector main body 42 reflects the downward light (the light emitted below the straight line T2 illustrated in FIG. 7), which is not incident as direct light on the lens 30 from the plurality of light-emitting elements 22, and causes the downward light to be incident as reflected light on the incident surface 31 of the lens 30. The reflective surface 41 of the reflector main body 42 performs light distribution control so as to emit light from a region of an emission surface 32 of the lens 30 below the lens optical axis a. More specifically, the reflective surface 41 is formed to reflect the light toward a region of the incident surface 31 of the lens 30 (a predetermined region of the incident surface 31) such that the light is emitted from the emission surface 32 below the lens optical axis a. According to the present embodiment, the above-described predetermined region of the incident surface 31 is a region of the incident surface 31 below the lens optical axis a. The light reflected by the reflective surface 41 is emitted as upward light from the emission surface 32 of the lens 30 (see FIG. 7). The light reflected by the reflective surface 41 is supposed to be the light that is not incident on the incident surface 31 of the lens 30 and is not used to form the light distribution pattern. The above-described light, which is not supposed to be used to form the light distribution pattern, is used to form the upward light by the reflective surface 41 of the reflector 40 so that the use efficiency of light can be improved.

An upper end portion of the reflector main body 42 is provided with a recessed portion 44 that is recessed downward. The recessed portion 44 is formed in a part of the upper end portion of the reflector main body 42 in the vehicle width direction. The recessed portion 44 according to the present embodiment is provided on the inner side with respect to the lens optical axis a in the vehicle width direction (see FIG. 2). The recessed portion 44 according to the present embodiment is provided on the outer side in the vehicle width direction with respect to the second light-emitting element 22 from the inner side (left side) in the vehicle width direction and on the inner side in the vehicle width direction with respect to the fifth light-emitting element 22 from the inner side in the vehicle width direction. That is, the recessed portion 44 according to the present embodiment is located on the front lower side of the third light-emitting element 22 and the fourth light-emitting element 22 from the inner side in the vehicle width direction. Accordingly, the reflective surface 41 of the reflector main body 42 includes a first reflective surface (partial region) 41a formed by a bottom surface of the recessed portion 44 and a second reflective surface 41b located on the outer side of the recessed portion 44. The second reflective surface 41b includes an adjacent region 41ba that is adjacent to the first reflective surface 41a in the vehicle width direction (hereinafter simply referred to as “adjacent region 41ba”). The adjacent regions 41ba according to the present embodiment are provided on both sides of the first reflective surface 41a in the vehicle width direction. The first reflective surface 41a is located at a position lower than the adjacent region 41ba in a side view (see FIG. 6). According to the present embodiment, the adjacent regions 41ba are provided on both sides of the first reflective surface 41a in the vehicle width direction, but the adjacent region 41ba may be provided only on one side (for example, the outer side) in the vehicle width direction.

As illustrated in FIG. 6, the first reflective surface 41a and the adjacent region 41ba have different inclination angles with respect to the lens optical axis a of the lens 30. An inclination angle θ1 of the first reflective surface 41a with respect to the lens optical axis a is smaller than an inclination angle θ2 of the adjacent region 41ba with respect to the lens optical axis a (θ1<θ2). That is, the inclination angle of a partial region (the first reflective surface 41a according to the present embodiment) of the reflective surface 41 in the vehicle width direction with respect to the lens optical axis a of the lens 30 is smaller than that of the adjacent region (the adjacent region 41ba according to the present embodiment) that is adjacent to the partial region in the vehicle width direction. The inclination angle with respect to the lens optical axis a refers to the inclination angle with respect to the lens optical axis a in a vertical cross-section (the cross-section illustrated in FIG. 6) including a straight line that passes through the light emission center O of the light-emitting element 22 and is parallel to the lens optical axis a.

Next, the light reflected from the first reflective surface 41a will be described with reference to FIG. 7. A linear arrow L1 illustrated in FIG. 7 indicates reflected light L1 that is reflected by the first reflective surface 41a according to the present embodiment. In addition, a dash-dot-dot line arrow L2 illustrated in FIG. 7 indicates virtual reflected light L2 in a case where the inclination angle θ1 of the first reflective surface 41a is set to be the same as the inclination angle θ2 of the adjacent region 41ba. Broken lines extending backward from the optical paths of the reflected lights L1, L2 indicate the reverse optical paths obtained by extending backward the optical paths of the reflected lights L1, L2, respectively.

As illustrated in FIG. 7, a part of the downward light that is not incident as direct light on the lens 30 from the predetermined light-emitting element 22 (for example, the third and fourth light-emitting elements 22 from the inner side in the vehicle width direction) located at the rear upper side of the recessed portion 44 among the plurality of light-emitting elements 22 is reflected by the first reflective surface 41a and is incident on the incident surface 31 of the lens 30 as the reflected light L1.

As illustrated in FIG. 7, the reflected light L1 reflected by the first reflective surface 41a from the light emission center O of the predetermined light-emitting element 22 is emitted above the virtual reflected light L2 in a case where the inclination angle θ1 of the first reflective surface 41a is set to be the same as the inclination angle θ2 of the adjacent region 41ba without providing the recessed portion 44. That is, the reflected light L1 reflected by the first reflective surface 41a from the light emission center O of the predetermined light-emitting element 22 is emitted above the virtual reflected light L2 in a case where the recessed portion 44 is not provided. Then, the lens 30 emits the reflected light L1 from the first reflective surface 41a above the virtual reflected light L2 in a case where the inclination angle θ1 of the first reflective surface 41a is set to be the same as the inclination angle θ2 of the adjacent region 41ba.

As illustrated in FIG. 7, on a vertical axis V included in a plane that passes through the light emission center O of the light-emitting element 22 and is perpendicular to the lens optical axis a, there is an intersection point F1 with the reverse optical path (hereinafter, referred to as the “reverse optical path of the reflected light LI”) obtained by extending backward the optical path of the reflected light L1 from the first reflective surface 41a. This is equivalent to light emission to the incident surface 31 of the lens 30 from one pseudo light source having a light emission center at the intersection point F1. The intersection point F1 is located below the light emission center O. Further, an intersection point F2 where the vertical axis V intersects with the reverse optical path (hereinafter, referred to as the “reverse optical path of the virtual reflected light L2”) obtained by extending backward the optical path of the virtual reflected light L2 in a case where the inclination angle θ1 of the first reflective surface 41a is set to be the same as the inclination angle θ2 of the adjacent region 41ba (in a case where the recessed portion 44 is not provided) is located below the light emission center O and above the intersection point F1. That is, the intersection point F1 where the reverse optical path of the reflected light L1 intersects with the vertical axis V passing through the light emission center O of the above-described predetermined light-emitting element 22 is located below the intersection point F2 in a case where the inclination angle θ1 of the first reflective surface 41a is set to be the same as the inclination angle θ2 of the adjacent region 41ba. The positional difference in the vertical direction between the intersection point F1 and the intersection point F2 corresponds to the difference in the height position of the pseudo light source and appears as a positional difference of a light distribution pattern described below in the vertical direction (see FIG. 8). The focal point of the lens 30 is located at the same position as the light emission center O of the light-emitting element 22 or in the vicinity thereof. The vertical axis V refers to a virtual axis in the vertical cross-section including a straight line parallel to the lens optical axis a and is not limited to an axis extending in the vertical direction. According to the present embodiment, the intersection point F1 where the reverse optical path of the reflected light Ll intersects with the vertical axis V passing through the light emission center O of the above-described predetermined light-emitting element 22 is located below the intersection point F2 in a case where the inclination angle θ1 of the first reflective surface 41a is set to be the same as the inclination angle θ2 of the adjacent region 41ba, but this is not a limitation.

Downward light that is not incident as direct light on the lens 30 from the light-emitting elements 22 other than the above-described predetermined light-emitting elements 22 among the plurality of light-emitting elements 22 is reflected by the second reflective surface 41b (including the adjacent region 41ba) and is incident as reflected light on the incident surface 31 of the lens 30.

According to the present embodiment, the reflector 40 separate from the heat sink 50 is fixed to the heat sink 50, but this is not a limitation, and for example, the reflector and the heat sink may be integrally molded. That is, the reflective surface 41 is not always provided on a member molded as the reflector 40.

### Lens

As illustrated in FIGS. 2 and 3, the lens 30 is, for example, a projection lens and is formed of an aspherical lens. The lens 30 includes the incident surface 31, the emission surface 32, and the lens optical axis a. The lens 30 is attached to the heat sink 50 via a lens holder (not illustrated). As illustrated in FIG. 2, the lens optical axis a according to the present embodiment passes through the fifth light-emitting element 22 from the outer side in the vehicle width direction. The focal point of the lens 30 is located at the same position as the light emission center O of the light-emitting element 22 or in the vicinity thereof.

The incident surface 31 is formed of an aspheric surface (according to the present embodiment, an aspheric surface close to a flat surface) and controls light from the plurality of light-emitting elements 22 to be incident on the lens 30 as incident light.

The emission surface 32 is formed of an aspheric surface (according to the present embodiment, an aspheric surface close to a spherical surface) and controls the incident light that is incident on the incident surface 31 to be emitted to the front side of the vehicle 1 as emission light. As described above, the lens 30 controls the direct light from the plurality of (12 according to the present embodiment) light-emitting elements 22 and the reflected light from the reflective surface 41 and emits the light to the front side of the vehicle 1 as a plurality of (12 according to the present embodiment) partial light distribution patterns. As described above, the lens 30 emits the reflected light L1 from the first reflective surface 41a above the virtual reflected light L2 in a case where the inclination angle θ1 of the first reflective surface 41a is set to be the same as the inclination angle θ2 of the adjacent region 41ba (see FIG. 7). According to the present embodiment, the lens 30 emits the reflected light L1 from the first reflective surface 41a above the virtual reflected light L2 in a case where the inclination angle θ1 of the first reflective surface 41a is set to be the same as the inclination angle θ2 of the adjacent region 41ba, but this is not a limitation.

The front shape of the lens 30 (the front shape of the emission surface 32) is a horizontally elongated shape having a narrow vertical width (up-down width) and a wide horizontal width (right-left width). The thickness (front-rear width) of the lens 30 is large at the central portion and gradually decreases from the central portion toward the peripheral portion. The lens 30 of the ADB type lamp units 10L, 10R needs to allow the light from the plurality of light-emitting elements 22 to be incident on the incident surface 31 and to be emitted from the emission surface 32 to the front side of the vehicle 1. Therefore, the radius of curvature of the incident surface 31 is large, and the radius of curvature of the emission surface 32 is smaller than the radius of curvature of the incident surface 31.

### Heat Sink

As illustrated in FIGS. 2 to 4, the heat sink 50 is a member that cools the light source unit 20 and is formed of a member having high thermal conductivity (for example, an aluminum die-cast member). The heat sink 50 integrally includes a plate-shaped attachment portion 51 and a fin-shaped heat dissipation portion 52. The plurality of light-emitting elements 22 of the light source unit 20 is attached to the front surface of the attachment portion 51 via the substrate 21. The left and right fixing portions 43L, 43R of the reflector 40 are fixed to the front surface of the attachment portion 51. The heat dissipation portion 52 is integrally provided on the rear surface of the attachment portion 51. The plurality of fins of the heat dissipation portion 52 according to the present embodiment is provided parallel or substantially parallel to one another in the vertical direction. The heat of the light source unit 20 generated from the light-emitting element 22 is radiated from the heat dissipation portion 52 of the heat sink 50.

### Fan Unit

As illustrated in FIGS. 2 to 4, the fan unit 60 is provided behind the heat dissipation portion 52 of the heat sink 50 and is attached to the heat sink 50. The fan unit 60 cools the heat sink 50 by directly blowing air to the heat sink 50, thereby enhancing the cooling effect of the light-emitting element 22 by the heat sink 50.

### Light Distribution Pattern

Next, the light distribution pattern will be described with reference to FIGS. 8 and 9.

FIG. 8 is a diagram illustrating light distribution patterns of the right lamp unit projected on a screen, in which (a) illustrates a state in which the recessed portion is not provided, (b) illustrates a state in which the recessed portion is provided, and (c) illustrates an increase in the light in (b) with respect to (a). FIG. 9 is a diagram illustrating light distribution patterns and changes in illuminance of a vehicle on a sidewalk, in which (a) illustrates a light distribution pattern in a state where the recessed portion is not provided, (b) illustrates a light distribution pattern in a state where the recessed portion is provided, and (c) illustrates a change in the illuminance in the vertical direction on a sidewalk. The line VU-VD in FIG. 8 indicates a vertical line passing through the lens optical axis of the right lamp unit on the screen, and the line HL-HR indicates a horizontal line at the height of the lens optical axis of the right lamp unit on the screen.

FIG. 8(a) and FIG. 9(a) illustrate the light distribution patterns in a state where the recessed portion (the first reflective surface 41a) is not provided, which is to be compared with the light distribution pattern according to the present embodiment, and FIG. 8(b) and FIG. 9(b) illustrate the light distribution patterns according to the present embodiment. In FIGS. 8 and 9, the light distribution pattern is indicated by iso-intensity curves, and the value of the light intensity of the iso-intensity curve at the center is high, while the value of the light intensity of the iso-intensity curve decreases toward the outer side (outer periphery). The solid line in FIG. 9(c) indicates changes in the illuminance in the vertical direction on the sidewalk in the cross-section taken along the line IX(c)-IX(c) in FIG. 9(b). The broken line in FIG. 9(c) indicates changes in the illuminance in the vertical direction on the sidewalk in the cross-section taken along the line IX(c)-IX(c) in FIG. 9(a). FIG. 8(a) and 8(b) illustrate a right high-beam light distribution pattern formed by superimposing the light distribution pattern formed by direct light that is directly incident on the lens 30 from the plurality of light-emitting elements 22 and the light distribution pattern formed by reflected light that is reflected by the reflective surface 41.

As illustrated in FIG. 8, the right high-beam light distribution pattern (see FIG. 8(b)) of the lamp unit 10R according to the present embodiment, in which the first reflective surface 41a is provided on the reflective surface 41, has a partially higher light intensity value than that of the right high-beam light distribution pattern (see FIG. 8(a)) in which the recessed portion (the first reflective surface 41a) is not provided on the reflective surface 41. According to the present embodiment, as illustrated in FIG. 8(c), the value of the light intensity is partially high in a partial region on the outer side in the vehicle width direction with respect to the center (the line VU-VD) in the vehicle width direction of the vehicle 1 and on the upper side with respect to the horizontal line (the line HL-HR). The light distribution pattern of the difference illustrated in FIG. 8(c) is a light distribution pattern by the reflected light L1 from the first reflective surface 41a.

As illustrated in FIG. 9, in the entire high-beam light distribution pattern (see FIG. 9(b)) of the vehicle 1 according to the present embodiment, the value of the light intensity on the sidewalk on the opposite lane side is partially higher than that in the entire high-beam light distribution pattern (see FIG. 9(a)) in a case where the recessed portion (the first reflective surface 41a) is not provided in the reflective surface 41. Accordingly, in the entire high-beam light distribution pattern, the region having a high light intensity on the sidewalk on the opposite lane side spreads outward in the vehicle width direction as compared with the case where the first reflective surface 41a is not provided (see FIG. 9(a)). Further, as illustrated in FIG. 9(c), the illumination intensity (the illumination intensity indicated by a solid line a in FIG. 9(c)) on the sidewalk on the opposite lane side in the entire high-beam light distribution pattern of the vehicle 1 according to the present embodiment is partially increased as compared with the case where the first reflective surface 41a is not provided (the illumination intensity indicated by a broken line b in FIG. 9(c)). These are caused by the reflected light LI from the first reflective surface 41a.

In the vehicle headlamp 100R configured as described above, the inclination angle θ1 of the first reflective surface 41a of the reflective surface 41 of the reflector 40 with respect to the lens optical axis a is smaller than that of the adjacent region 41ba that is adjacent to the first reflective surface 41a in the vehicle width direction. Accordingly, the intersection point F1 where the reverse optical path of the reflected light L1 intersects with the vertical axis V included in the plane that passes through the light emission center O of the above-described predetermined light-emitting element 22 and is perpendicular to the lens optical axis a is located below the intersection point F2 where the reverse optical path of the virtual reflected light L2 in a case where the inclination angle θ1 of the first reflective surface 41a is set to be the same as the inclination angle θ2 of the adjacent region 41ba intersects with the above-described vertical axis V. Then, the lens 30 emits the reflected light L1 from the first reflective surface 41a above the virtual reflected light L2 in a case where the inclination angle θ1 of the first reflective surface 41a is set to be the same as the inclination angle θ2 of the adjacent region 41ba. As described above, the positional difference between the intersection point F1 and the intersection point F2 in the vertical direction corresponds to the positional difference between the pseudo light sources and appears as the positional difference between the light distribution patterns in the vertical direction (see FIG. 8); therefore, it is possible to adjust the partial light distribution of the entire high-beam light distribution pattern.

Further, since the first reflective surface 41a is a partial region of the reflective surface 41 of the reflector 40 in the vehicle width direction, partial light distribution of the entire high-beam light distribution pattern can be adjusted by appropriately setting the position of the first reflective surface 41a with respect to the reflective surface 41 in the vehicle width direction. For example, as in the present embodiment, the light distribution on the sidewalk on the opposite lane side in the entire high-beam light distribution pattern can be adjusted. Thus, the visibility of the pedestrian or the like existing on the sidewalk can be enhanced, and the safety can be improved.

As described above, according to the present embodiment, it is possible to provide a vehicle lamp with which the light distribution can be partially adjusted.

Further, the first reflective surface 41a is provided at an upper end portion of the reflective surface 41 of the reflector 40. When light rays enter the lens 30 from the direction in which the light is desired to be increased (the region illustrated in FIG. 8(c)), the light is collected at the upper end portion of the reflective surface 41 of the reflector 40 (the reverse optical path from the screen). Therefore, by appropriately setting the inclination angle θ1 of the first reflective surface 41a and reflecting the light reflected by the upper end portion of the reflective surface 41 of the reflector 40 along the reverse optical path from the screen, it is possible to brighten the portion on the screen (the region illustrated in FIG. 8(c)).

Further, since the first reflective surface 41a is provided on the inner side in the vehicle width direction with respect to the lens optical axis a, it is possible to adjust partial light distribution on the outer side in the vehicle width direction in the entire high-beam light distribution pattern. Thus, the visibility of the pedestrian or the like existing on the sidewalk can be enhanced, and the safety can be improved.

Further, since the recessed portion 44 is formed in the reflective surface 41 of the reflector main body 42 and the bottom surface of the recessed portion 44 functions as the first reflective surface 41a, the first reflective surface 41a can be provided on the reflective surface 41 with a simple configuration.

Further, the reflective surface 41 of the reflector 40 is provided below the lower end (the position indicated by the straight line T2 in FIG. 7) of the range in which the light from the light-emitting element 22 is incident as direct light on the incident surface 31 of the lens 30 in the vertical cross-section including the straight line that passes through the light emission center O of the light-emitting element 22 and is parallel to the lens optical axis a. Therefore, the reflective surface 41 of the reflector 40 does not block the direct light incident on the lens 30 from the light-emitting element 22 and allows the downward light (the light emitted below the straight line T2 illustrated in FIG. 7), which is not incident on the lens 30 as direct light, to be incident on the lens 30 as reflected light.

### Modification of Reflector

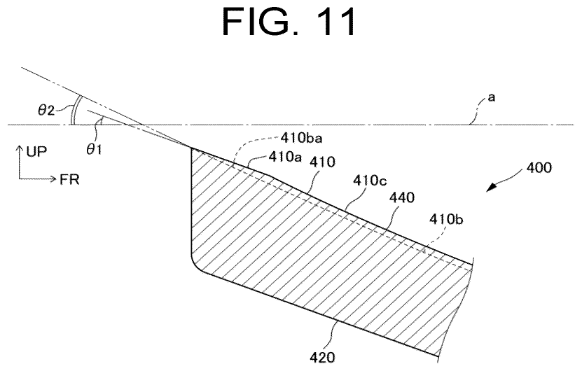

According to the present embodiment, the recessed portion 44 is provided on the reflective surface 41 of the reflector 40, but this is not a limitation, and for example, as illustrated in FIGS. 10 and 11, a protruding portion 440 may be provided on a reflective surface 410 of a reflector 400.

FIG. 10 is a perspective view illustrating a modification of the reflector. FIG. 11 is a cross-sectional view taken along the line XI-XI of FIG. 10.

As illustrated in FIGS. 10 and 11, the reflector 400 includes a reflector main body 420 and left and right fixing portions 430L, 430R fixed to the heat sink 50.

The reflective surface 410 (upper surface) of the reflector main body 420 is provided with a strip-shaped protruding portion 440 that extends in the front-rear direction from the upper end to the lower end of the reflective surface 410 in an upwardly protruding state. The protruding portion 440 is formed on a part of the reflector main body 420 in the vehicle width direction. The vehicle width position (the position in the vehicle width direction) where the protruding portion 440 is provided may be, for example, the inner side in the vehicle width direction with respect to the lens optical axis a, similarly to the recessed portion 44 of the reflector 40 described above. That is, the protruding portion 440 may be located on the front lower side of the third light-emitting element 22 and the fourth light-emitting element 22 from the inner side in the vehicle width direction.

The upper surface of the upper end portion of the protruding portion 440 has a smaller inclination angle with respect to the lens optical axis a than the upper surface of a lower region 410c extending downward from the upper end portion. The upper surface of the upper end portion of the protruding portion 440 functions as a first reflective surface (partial region) 410a. Second reflective surfaces 410b are provided on both sides of the protruding portion 440 in the vehicle width direction. That is, the reflective surface 410 of the reflector main body 420 includes the first reflective surface (partial region) 410a formed by the upper surface of the upper end portion of the protruding portion 440, the lower region 410c of the protruding portion 440 extending downward from the first reflective surface 410a, and the second reflective surfaces 410b located on both sides of the protruding portion 440 in the vehicle width direction. The second reflective surface 410b includes an adjacent region 410ba that is adjacent to the first reflective surface 410a in the vehicle width direction. The adjacent regions 410ba are provided on both sides of the first reflective surface 410a in the vehicle width direction. The first reflective surface 410a according to the present embodiment is located at a position higher than the adjacent region 410ba in a side view (see FIG. 11).

As illustrated in FIG. 11, the first reflective surface 410a and the adjacent region 410ba have different inclination angles with respect to the lens optical axis a of the lens 30. The inclination angle θ1 of the first reflective surface 410a with respect to the lens optical axis a is smaller than the inclination angle θ2 of the adjacent region 410ba with respect to the lens optical axis a (θ1<θ2). That is, the partial region (the first reflective surface 410a according to the present embodiment) of the reflective surface 410 in the vehicle width direction has a smaller inclination angle with respect to the lens optical axis a than the adjacent region (the adjacent region 410ba according to the present embodiment) that is adjacent to the partial region in the vehicle width direction. Even in the reflective surface 410, the intersection point F1 where the reverse optical path of the reflected light L1 reflected by the first reflective surface 410a intersects with the above-described vertical axis V is located below the intersection point F2 where the reverse optical path of the virtual reflected light L2 in a case where the inclination angle θ1 of the first reflective surface 410a is set to be the same as the inclination angle θ2 of the adjacent region 410ba intersects with the above-described vertical axis V.

The lower region 410c of the protruding portion 440 is provided at a position higher than the second reflective surface 410b in the thickness direction. The inclination angle of the lower region 410c of the protruding portion 440 with respect to the lens optical axis a according to the present embodiment is substantially the same as the inclination angle of the second reflective surface 410b with respect to the lens optical axis a.

Even in the vehicle headlamp 100R to which the reflector 400 is applied, partial light distribution of the entire high-beam light distribution pattern can be adjusted in the same manner as in a case where the reflector 40 according to the above-described embodiment is applied. Therefore, it is possible to provide the vehicle lamp with which the light distribution can be partially adjusted.

Furthermore, by providing the protruding portion 440 on the reflective surface 410, the effect by the first reflective surface 410a becomes the same as the effect by the first reflective surface 41a according to the first embodiment, and the angle in the vertical direction of the reflected light in the lower region 410c becomes substantially the same as that in the adjacent region 410ba, so that there is almost no influence on the light distribution. That is, by forming the first reflective surface 410a by providing the protruding portion 440 on the reflective surface 410, the light reflected from the first reflective surface 410a changes the light distribution, and by adjusting the amount of protrusion of the protruding portion 440, the influence of the lower region 410c on the light distribution can be changed.

Although the present invention has been described based on the above-described embodiment, the present invention is not limited to the contents of the above-described embodiment, and can be appropriately modified without departing from the scope of the present invention. That is, it is a matter of course that other embodiments, examples, operation techniques, and the like made by those skilled in the art and the like based on the present embodiment are all included in the scope of the present invention.

### DESCRIPTION OF REFERENCE NUMERALS

1 VEHICLE
10R LAMP UNIT
20 LIGHT SOURCE UNIT
22 LIGHT-EMITTING ELEMENTS
30 LENS
40, 400 REFLECTOR
41, 410 REFLECTIVE SURFACE
41a, 410a FIRST REFLECTIVE SURFACE (PARTIAL REGION)
41ba, 410ba ADJACENT REGION
44 RECESSED PORTION
100R VEHICLE HEADLAMP (VEHICLE LAMP)
440 PROTRUDING PORTION

1. A vehicle lamp mounted on a front portion of a vehicle, the vehicle lamp comprising:
a light source unit including a plurality of light-emitting elements arranged horizontally in a vehicle width direction;
a lens provided in front of the light source unit; and
a reflective surface that is provided below the plurality of light-emitting elements and between the light source unit and the lens and that reflects downward light, which is not incident as direct light on the lens from the plurality of light-emitting elements, and causes the downward light to be incident on the lens as reflected light, wherein
an inclination angle of a partial region of the reflective surface in the vehicle width direction with respect to a lens optical axis of the lens is smaller than an inclination angle of an adjacent region that is adjacent to the partial region in the vehicle width direction.

2. The vehicle lamp according to claim 1, wherein
an intersection point where a reverse optical path obtained by extending backward an optical path of reflected light from the partial region of the reflective surface intersects with a vertical axis included in a plane that passes through a light emission center of the light-emitting element and is perpendicular to the lens optical axis is located below the intersection point in a case where the inclination angle of the partial region is set to be the same as the inclination angle of the adjacent region, and
the lens emits the reflected light from the partial region of the reflective surface, beyond reflected light in a case where the inclination angle of the partial region is set to be the same as the inclination angle of the adjacent region.

3. The vehicle lamp according to claim 1, wherein the partial region of the reflective surface is provided on an inner side in the vehicle width direction with respect to the lens optical axis.

4. The vehicle lamp according to claim 1, wherein the partial region of the reflective surface is provided at an upper end portion of the reflective surface.

5. The vehicle lamp according to claim 4, wherein
the upper end portion of the reflective surface is provided with a recessed portion that is recessed downward, and
the partial region of the reflective surface is a bottom surface of the recessed portion.

6. The vehicle lamp according to claim 4, wherein
the reflective surface is provided with a strip-shaped protruding portion that extends from an upper end to a lower end of the reflective surface in an upwardly protruding state, and
the partial region of the reflective surface is an upper surface of an upper end portion of the protruding portion.

7. The vehicle lamp according to claim 2, wherein the reflective surface is provided below a straight line connecting a lower end of an incident surface of the lens, on which direct light from the light-emitting element is incident, and the light emission center of the light-emitting element in a vertical cross-section including a straight line that passes through the light emission center of the light-emitting element and is parallel to the lens optical axis.
